(19) United States
(12) Patent Application Publication
(10) Pub. No.: US 2022/0348107 A1
(43) Pub. Date: Nov. 3, 2022

(54) METHODS AND SYSTEMS FOR END-TO-END INFRASTRUCTURE FOR SUPPORTING USE OF SWAPPABLE BATTERIES IN ELECTRIC VEHICLES

(71) Applicant: Popion Mobility Inc., Burlingame, CA (US)

(72) Inventor: Hadi Hajimiri, Burlingame, CA (US)

(21) Appl. No.: 17/306,564

(22) Filed: May 3, 2021

(51) Int. Cl. B60L 53/80; B60L 53/62; B60L 53/30; B60L 53/16; B60L 55/00; B60L 53/68; B60L 53/65; B60L 53/66; B60S 5/06; G05B 15/02; H02J 7/00

(52) U.S. Cl. CPC B60L 53/80; B60L 53/62; B60L 53/305; B60L 53/16; B60L 55/00; B60L 53/68; B60L 53/65; B60L 53/66; B60S 5/06; G05B 15/02; H02J 7/0013

(57) ABSTRACT

Systems and methods are provided for end-to-end infrastructure for supporting use of swappable batteries in electric vehicles. An end-to-end infrastructure for supporting use of electric vehicles may include one or more battery-swapping fueling stations. Each battery-swapping fueling station is configured to maintain one or more swappable batteries configured for operation in the electric vehicles, charge each of the one or more swappable batteries, when not fully charged, and swap, using the one or more swappable batteries, at least one battery of at least one electric vehicle when the at least one electric vehicle is refueling at the battery-swapping fueling station.

### BACKGROUND

Aspects of the present disclosure relate to energy solutions. More specifically, certain embodiments in accordance with the present disclosure relate to methods and systems for end-to-end infrastructure for supporting use of swappable batteries in electric vehicles.

Various issues may exist with conventional solutions for powering electric vehicles. In this regard, conventional systems and methods for powering electric vehicles, particularly using rechargeable batteries, may be costly, cumbersome, and/or inefficient.

Limitations and disadvantages of conventional systems and methods will become apparent to one of skill in the art, through comparison of such approaches with some aspects of the present methods and systems set forth in the remainder of this disclosure with reference to the drawings.

### BRIEF SUMMARY

System and methods are provided for end-to-end infrastructure for supporting use of swappable batteries in electric vehicles, substantially as shown in and/or described in connection with at least one of the figures, as set forth more completely in the claims.

These and other advantages, aspects and novel features of the present disclosure, as well as details of one or more illustrated example embodiments thereof, will be more fully understood from the following description and drawings.

### BRIEF DESCRIPTION OF THE DRAWINGS

FIG. 1 illustrates an example end-to-end infrastructure for supporting use of swappable batteries in electric vehicles.

FIG. 2 illustrates example use of swappable batteries in various types of vehicles.

FIG. 3 illustrates an example use scenario for deploying swappable batteries in a truck.

FIG. 4 illustrates an example use of swappable batteries in an electric vehicle.

FIG. 5 illustrates an example battery interface for use with swappable batteries in electric vehicles.

FIG. 6 illustrates example use of Smart swappable batteries with cloud-based control system.

FIG. 7 illustrates an example battery-swapping fueling station.

FIG. 8 illustrates an example mobile battery-swapping fueling station.

FIG. 9 illustrates an example powered battery handling arm for use in swapping batteries in a battery-swapping fueling stations.

FIG. 10 illustrates an example rack of battery bays for use in battery-swapping fueling stations.

FIG. 11 illustrates example grid connections of a battery-swapping fueling station.

FIG. 12 illustrates example use of battery-swapping fueling stations with cloud-based control system.

### DETAILED DESCRIPTION

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

The terminology used herein is for the purpose of describing particular examples only and is not intended to be limiting of the disclosure. As used herein, the singular forms are intended to include the plural forms as well, unless the context clearly indicates otherwise. It will be further understood that the terms “comprises,” “includes,” “comprising,” “including,” “has,” “have,” “having,” and the like when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present disclosure. Similarly, various spatial terms, such as “upper,” “lower,” “side,” and the like, may be used in distinguishing one element from another element in a relative manner. It should be understood, however, that components may be oriented in different manners, for example an electronic device may be turned sideways so that its “top” surface is facing horizontally and its “side” surface is facing vertically, without departing from the teachings of the present disclosure.

As used in this disclosure, “vehicles” may comprise privately and/or publically owned and/or operated vehicles (e.g., individual user vehicles, vehicles of private fleets, vehicles of public fleets, etc.), and may comprise vehicles configured for transportation functions (e.g., people and/or cargo) as well as vehicles configured for various non-transportation functions (e.g., construction, mining, industrial, commercial, etc.). Further, as used in this disclosure, “vehicles” may be human-operated vehicles, autonomous vehicles, remote controlled vehicles, etc. Further, while many example implementations or examples are provided using ground-based vehicles, the disclosure is not so limited, and various features of the disclosure may apply in substantially similar manner to water-based and/or air-based vehicles (e.g., boats, airplanes, etc.). Examples of vehicles as used herein may comprise automobiles, buses, trucks, construction or mining vehicles (bulldozers, dump trucks, etc.), forklifts, boats, and the like.

As used in this disclosure, an electric vehicle comprises a vehicle that uses one or more electric motors (or other electric-based engine or system) for propulsion. The electric propulsion may be used the exclusive mode of operation or may be used in conjunction with other modes/types (e.g., conventional internal combustion based systems). Various solutions may be used for providing the electrical power required for the electric propulsion systems of electric vehicles. Example solutions may comprise use of systems for collecting electricity from off-vehicle sources (e.g., solar panels, etc.), or use of self-contained systems, such as batteries, solar panels, fuel cells, etc.

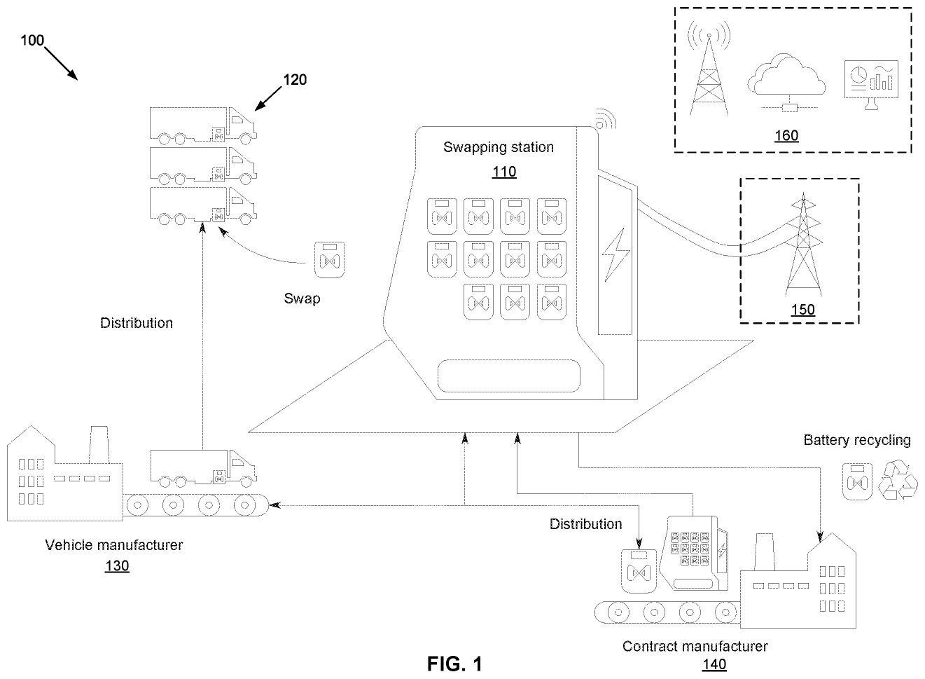

FIG. 1 illustrates an example end-to-end infrastructure for supporting use of swappable batteries in electric vehicles. Show in FIG. 1 is infrastructure 100 that supports use of swappable batteries in electric vehicles.

The infrastructure 100 comprises a plurality of battery-swapping fueling stations 110 that may be configured for providing fueling services, particularly by use of battery-swapping, to electric vehicles 120. The infrastructure 100 may also comprise additional elements that may be used for supporting the battery-swapping fueling stations 110 and/or operations thereof. Such additional elements may comprise vehicle manufacturers 130, contract manufacturers 140, electrical grid (network) 150, cloud-based systems 160, etc.

The battery-swapping fueling stations 110 may comprise various components for facilitating and supporting the battery swapping operations, as well as for supporting ancillary functions and services. While the battery-swapping fueling station 110 is illustrated as a fixed structure, the disclosure is not so limited, and as such in some instances battery-swapping fueling stations may be configured for mobility—that is, with at least some components of the battery-swapping fueling station being mobile, to enable (re-)deployment at different locations, etc. Battery-swapping fueling stations are described in more detail below.

The vehicle manufacturers 130 may comprise manufacturing resources associated with manufacturing of electric vehicles. This may include original manufacturers as well as after-market modification providers. The vehicle manufacturers 130 may provide vehicles configured for supporting use of swappable batteries. This may comprise building or configuring vehicles to use electric propulsion systems, to provide all or at least portion of the propulsion for operating the vehicles, with at least a portion of the required electrical power being provided by batteries deployed in the vehicles. In this regard, supporting use of swappable batteries may further comprise incorporating components for receiving and mating with the batteries—e.g., suitable battery housings, as described herein.

The contract manufacturers 140 may comprise manufacturing resources configured for manufacturing components or equipment used in conjunction with battery swapping operations. The contract manufacturers 140 may be used in manufacturing the swappable batteries and/or components thereof, the battery-swapping fueling stations and/or components or equipment thereof, etc. In some instances, the contract manufacturers 140 may also support recycling and/or disposal operations, to allow for recycling or disposal of swappable batteries, components or equipment of battery-swapping fueling stations, etc.

The electrical grid (network) 150 may comprise an interconnected network configured for electricity delivery from producers to end-users (residential, commercial, industrial, etc.). While not shown in FIG. 1, the electrical grid 150 comprises in its entirety such elements as power generation components (e.g., power generation stations, solar or wind farms, etc.), electrical substations configured to manipulated voltage in conjunction with transmission operations (e.g., step voltage up), electric power transmission components configured for carrying power over long distances, electric power distribution components configured for distributing power to the end-users and manipulated voltage in conjunction with distribution operations (e.g., step voltage down again, such as based on predetermined required service voltages).

The cloud-based systems 160 may comprise cloud-based computing resources that may be configured for providing cloud-based management functions, particularly with respect to managing the batteries and battery-swapping fueling stations. The cloud-based systems 160 may be configured to provide, for example, cloud-based monitoring, control, and management, including, e.g., providing updated control data, modifying operations of battery-swapping fueling stations, providing network-wide dynamic information (status, availability, etc.) and the like. Such systems are described in more detail below.

In operation, the infrastructure 100 may be used in facilitating and supporting use of swappable batteries in conjunction with operating electric vehicles, and for optimizing such use of swappable batteries. In this regard, as noted above, electric vehicles use electric systems (e.g., motors) for providing at least a portion of the propulsion required for operating the vehicles. While various solutions may be used in providing the required electrical power, the most common approach is to use batteries (or other similar electrical storage/discharge components). Use of batteries may pose some challenges and/or may have some shortcomings, however.

For example, ranges and/or endurance may be relatively short when using electric propulsion based on (exclusively) batteries for power supply. Further, recharging batteries may be a lengthy process. While these conditions may be acceptable in some use scenarios (e.g., in private use of personal vehicles especially within urban areas, where users may not drive long distances, and may simply recharge the batteries overnight), such conditions may pose severe logistical and operational challenges in other use scenarios—e.g., in conjunction with commercial use, with large vehicles, for long distance and/or long duration operations, etc. Therefore, solutions that overcome such limitations in battery-based use scenario/implementations are desirable.

In accordance with the present disclosure, at least some of the limitations associated with use of batteries for electric propulsion in electric vehicles may be overcome, particularly by use of battery-swapping fueling stations configured for swapping batteries, and for doing so in optimal manner—e.g., quickly, efficiently, and cost-effective way. In this regard, rather requiring the electric vehicle remain inoperable or stationary while being recharged, the use of battery-swapping stations allows for swapping spent (or almost-spent) batteries in electric vehicles with fully (or almost fully) charged batteries from the stations. The swapped-out batteries may then be recharged in the stations and re-used when fully charged. Use of such battery-swapping stations may be particularly advantageous for larger electric vehicles and/or for operators of large fleets of such vehicles, who may be particularly interested in reducing down time and/or increasing range as much as possible.

In various implementations, the infrastructure 100 may incorporate and/or may operate based on billing/compensation model that applies to the various parties using or supporting the infrastructure. For example, users of the swapping stations may pay for the swapping of the batteries on a per-use basis, or may do so using a subscription based service. In some instances, the infrastructure may be configured to account for “remaining charge” in the batteries, and thus the user may be given credit for requiring less than full recharge. In addition, the infrastructure may be configured to account for recycling cost, with at least some of the cost being passed to the users.

Relatedly, the infrastructure may incorporate support for user and/or device authentication. The user authentication may be built into the subscription based service, for example. Also, device identification validation may be performed, to ensure that only approved batteries are used in the infrastructure. The infrastructure 100 may support or incorporate green technologies and/or practices. For example, disposal of batteries or other components may be done in environmental conscious manner, with components or equipment being recycled where possible.

In some implementations, performance may be optimized by incorporating into the electric vehicle resource for recharging the batteries—e.g., using regenerative capabilities in the electric vehicle, such as based on braking, or by use of other existing non-electric powertrain.

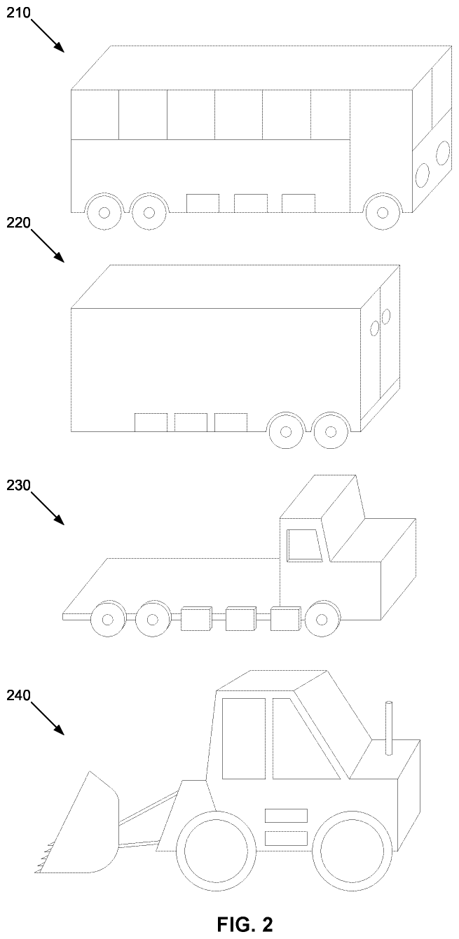

FIG. 2 illustrates example use of swappable batteries in various types of vehicles. Shown in FIG. 2 are various types of electric vehicles which may be configured for supporting and using battery-swapping based solutions, in accordance with the present disclosure.

In particular, illustrated in FIG. 2 are a bus 210, a truck 220, a trailer (e.g., reefer) 230, and a wheeled bulldozer 240. Each of these vehicles may be configured for operation as an electric vehicle, and particularly for supporting and using battery-swapping based solutions in conjunction with their operations as electric vehicles. As illustrated in FIG. 2, each of these electric vehicles may incorporate battery housing(s) for receiving swappable batteries, and for supporting use of these swappable batteries, particularly in conjunction with use of battery-swapping fueling stations that are configured for swapping these batteries as described herein.

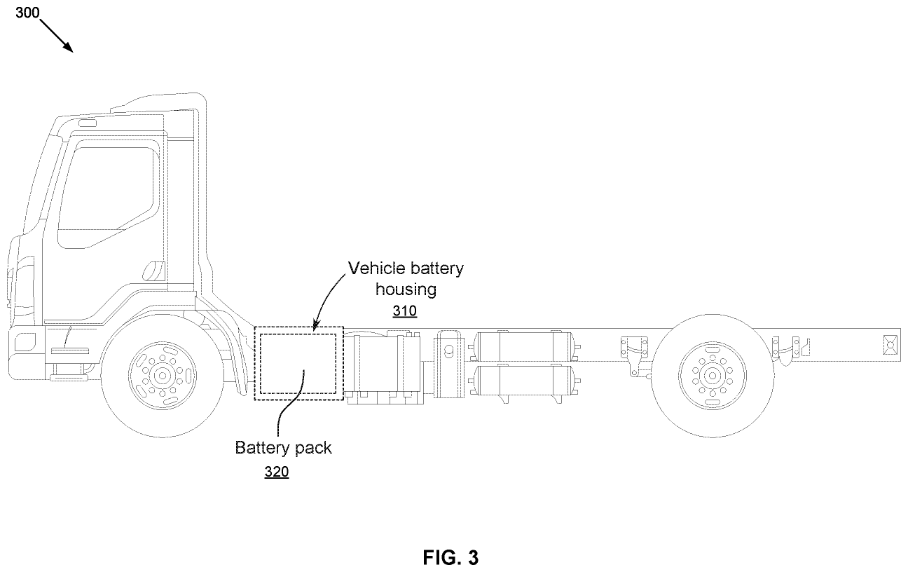

In this regard, as described above, the battery housings used in receiving and mating with the swappable batteries may be designed and/or implemented to allow for versatility and adaptability of deployment, and to allow for ease of swapping to optimize operation (e.g., by reducing complexity and/or time required for swapping the batteries). For example, the battery housings may be configured on one or more preset battery configurations (e.g., based on size, such as width, height and depth), support one or more predefined interfaces (e.g., predefined connections for mating the battery to the electric vehicle, predefined profiles and protocols for power delivery/transfer and/or communications via the connections, etc.). Also, the number and location of the battery housings used may be adaptively determined or set for different electric vehicles, such as based on anticipated power use, operation conditions (e.g., to avoid placing batteries where they are more likely be damaged), etc. Further, to enhance operation, the battery housing may be weather proofed (with or without door(s)). An example implementation of an electric truck is described in more detail with respect to FIG. 3.

FIG. 3 illustrates an example use scenario for deploying swappable batteries in a truck. Shown in FIG. 3 is a truck 300 that is configured for supporting and using battery-swapping based solutions, in accordance with the present disclosure.

The truck 300 may be configured for operation as an electric vehicle, and particularly for supporting use of each of these electric vehicles may incorporate battery housing(s) for receiving swappable batteries. In this regard, the truck 300 may be configured for utilizing batteries that provide electricity to provide or facilitate at least some of the propulsion required for operation of the truck.

For example, as shown in FIG. 3, the truck 300 may incorporate battery housing(s) 310 for receiving swappable batteries 320, and for supporting use of these batteries, particularly in conjunction with battery-swapping fueling stations that are configured for swapping these batteries as described herein. In this regard, as noted above, the number and location of the battery housings used in electric vehicles may be adaptively determined or set based on the electric vehicle (or type thereof). Therefore, to facilitate use of swappable batteries in trucks (e.g., the truck 300), truck specific mounting may be used. In this regard, battery housings may be installed in, for example, the same location used for traditional fuel tanks, as illustrated in FIG. 3, with the battery housings mounted on the side (e.g., using saddle mount on the truck's frame rails).

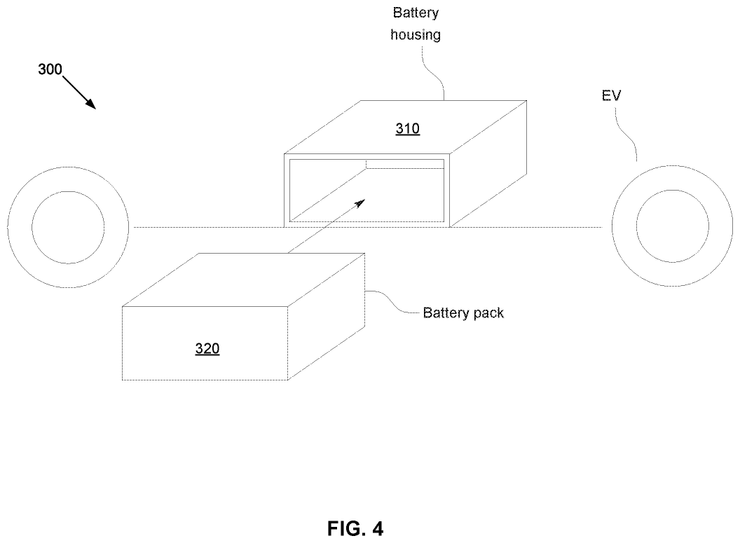

FIG. 4 illustrates an example use of swappable batteries in an electric vehicle. Shown in FIG. 4 is an example use scenario for inserting a swappable battery into an electric vehicle (e.g., the truck 300 for FIG. 3) that is configured for supporting and using battery-swapping based solutions.

As illustrated in FIG. 4, a swappable battery (e.g., the swappable battery 320 of FIG. 3) may be inserted into a corresponding battery housing (e.g., the battery housing 310 of FIG. 3) in the electric vehicle. In this regard, in various implementations in accordance with the present disclosure, batteries may be configured to fit into corresponding housing (in the vehicle, such as the battery housing 310, and/or within battery-swapping fueling stations, such via corresponding charger housings implemented therein) in a drawer-like slide motion, as shown in FIG. 4. Use of such drawer-like slide may be advantageous as it would greatly enhance the speed and ease of swapping operation.

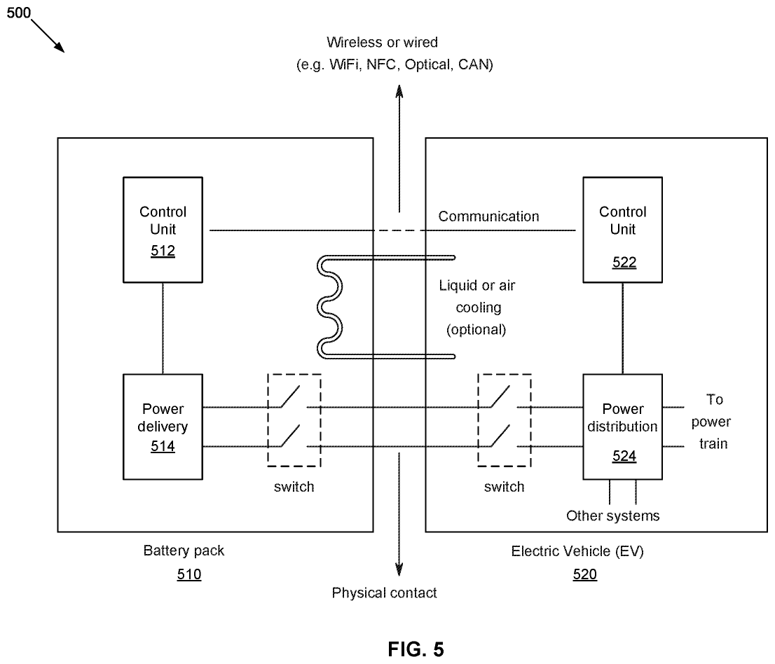

FIG. 5 illustrates an example battery interface for use with swappable batteries in electric vehicles. Shown in FIG. 5 is a battery interface 500 between a swappable battery 510 and an electric vehicle 520.

The battery interface 500 may comprise one or more connections. The connections may be of various types, such as wired, wireless, and optical. Examples of wired connections include Controller Area Network (CAN bus) based connections. Examples of wireless connections include Wi-Fi (Wireless Fidelity), NFC (Near-Field Communication), etc. based connections. The connections of the battery interface 500 may be utilized primarily in providing power from the swappable battery 510 into the electric vehicle 520, but may also be used in or configured for providing or supporting other functions.

For example, the connections of the battery interface 500 may be used in supporting or facilitating communication related functions, which may be used in conjunction with management and/or control related functions. Further, in some instances, the battery interface 500 may include heating, ventilation, and air conditioning (HVAC) based connections, which may be used in supporting or facilitating HVAC relating functions—e.g., for ensuring that the battery 510 operates in under optimal conditions. In this regard, the HVAC based connections may be used for heating, cooling, ventilating, or any combination thereof of the battery 510, such as based on a pre-defined climatic profile for the battery. Various types of HVAC connections may be used or supported. For example, the battery interface 500 may incorporate liquid or air cooling connections.

The swappable battery 510 and the electric vehicle 520 may comprise suitable components for supporting and utilizing the battery interface 500 and/or connections thereof. In this regard, such components may comprise suitable circuitry (either dedicated or existing circuitry) configured to provide functions associated with the battery interface 500. In the example implementation illustrated in FIG. 5, the swappable battery 510 comprises battery-side control unit 512 and a power delivery unit 514, whereas the electric vehicle 520 comprises a vehicle-side control unit 522 and a power distribution unit 524. Each of the battery-side control unit 512, the power delivery unit 514, the vehicle-side control unit 522, and the power distribution unit 524 may comprise suitable circuitry configured for performing the operations or functions attributed thereto.

With respect to power delivery or energy transfer, power may be delivered from the swappable battery 510 into the electric vehicle 520 via the battery interface 500 through one or more connections between the power delivery unit 514 and the power distribution unit 524. In some instances, the connections may comprise switching elements to allow for selective delivery of power. In this regard, the switching elements may be used to enable delivery of power (e.g., by closing the switching elements, thus completing the connections) or disable delivery of power (e.g., by opening the switching elements, thus disconnecting the connections) under particular conditions. This control may be done using control signals (e.g., by the battery-side control unit 512 and/or the vehicle-side control unit 522, such as based on a state machine).

Various types of communication may be performed via the battery interface 500. For example, communication may comprise power delivery (or energy transfer) communication sequence (e.g., safety checks, handshakes, etc.). Power-related communication may also be used for controlling certain aspects of power delivery, such as independent pack energy transfer rate (e.g., based on requests and control signals issued by the electric vehicles 520, such as via the vehicle-side control unit 522). Communication may also comprise exchange data (e.g., GPS position), negotiation of parameters (e.g., max voltage, current limits, etc.). Another type of communication via the battery interface 500 comprise discoverable application layer protocols related communications (e.g., value added services).

In an example implementation, the battery interface 500 may be configured for operation in accordance with a predefined state machine. Such state machine may comprise one or more states, with corresponding conditions for transition to and/or from, and/or actions that may be performed in each state. An example state machine may comprise such energy transfer states as 1) “Not mated”, 2) “Initialization”, 3) “Energy Transfer”, 4) “Shutdown”, and 5) “Error/Malfunction.”

In this regard, the “Not mated” may correspond to vehicle proximity not being detected, with the communication link(s) not being established. In the “Initialization” state, the battery may be mated to a battery housing/EV, but may not be ready to initiate transfer of power, though communication between the battery and the electric vehicle is established (though other supplemental processes are not complete). In the “Energy Transfer” state the vehicle contactor(s) may be closed, current suppression may be active, and periodic parameter renegotiation may be ongoing. In the “Shutdown” state, pre-disconnecting procedure may be executed. The “Error/Malfunction” state may be triggered in response to safety check failure(s) and/or other errors, and shutdown and disconnect procedures may be executed. This may be done after a predefined time (e.g., 100 ms), such as to allow for any possible recovery.

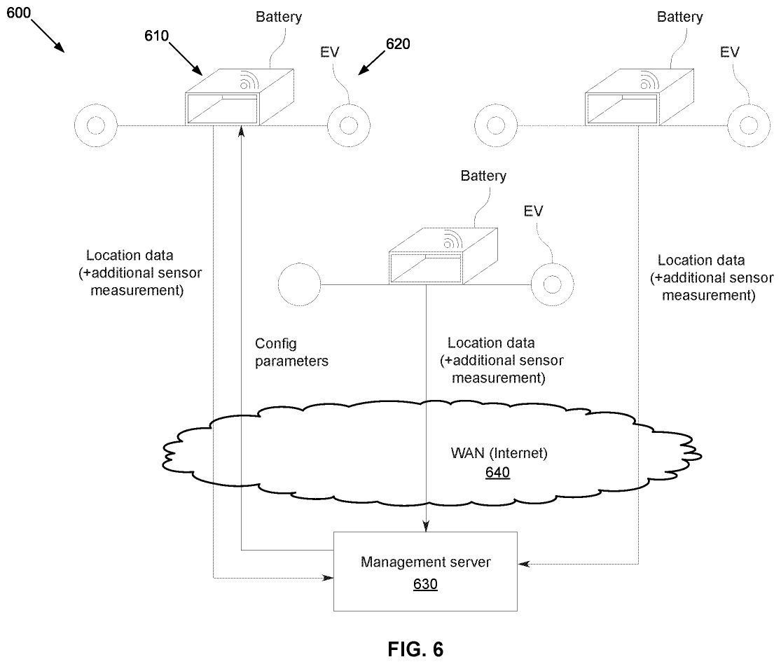

FIG. 6 illustrates example use of Smart swappable batteries with cloud-based control system. Shown in FIG. 6 is a cloud-based network 600 configured for managing a plurality of swappable batteries 610 deployed in corresponding plurality of electric vehicles (EVs) 620. The cloud-based network 600 may comprise a cloud-based management server 630, which may interact with, and provide management services relating to the plurality of swappable batteries 610, such as via Wide area network (WAN) (e.g., Internet-based cloud) 640.

The cloud-based management server 630 may be configured to manage, support, and control swappable batteries and use thereof as described in this disclosure. The cloud-based management server 630 may comprise, for example, suitable circuitry (including, e.g., one or more of communication circuit(s), circuit(s), processing circuit(s), etc.) for performing the various functions and/or operations attributed to the cloud-based management server 630, particularly with respect to managing, supporting, and controlling swappable batteries.

While the cloud-based management server 630 is illustrated in FIG. 6 as a single device/system, the disclosure is not so limited. In this regard, in some instances, solutions in accordance with the present disclosure may be implemented in a distributed manner, with various functions attributed to the cloud-based management server 630 being performed by various elements (e.g., servers or other suitable systems) within or coupled to the WAN 640. Thus, in some example implementations, the cloud-based management server 630 may be implemented in a distributed manner, with some of the functions and/or operations attributed thereto being performed by different physical systems, devices or components that are part of and/or connected to the WAN 640.

In various implementations, swappable batteries may be configured to support communication functions, and such may be cloud-connected. This may be done by, for example, incorporating communication related resources (e.g., radios, transceiver circuitry, etc.) within the batteries. Alternatively, the batteries may utilize other systems for providing and facilitating communication services. For example, the battery housing may incorporate communication resources, and batteries may utilize such communication resources via the battery interface (e.g., interface 500 as described with respect to FIG. 5). The batteries may also use communication resources of the electric vehicles (e.g., via the battery housing and the battery interface).

The cloud-connectivity may be utilized to support and/or optimize operation of the batteries. For example, batteries may be configured to utilize to the cloud-connectivity to continuously send data to cloud-based management servers (e.g., the cloud-based management server 630), which may use that data in enhancing or optimizing operation of the batteries. The data may comprise, for example, location related information (e.g., positioning related data, such as Global Positioning System (GPS) based location data), sensory information (e.g., sensor measurements), and the like. The cloud-based management servers (e.g., the cloud-based management server 630) may also utilize cloud-connectivity to communicate with the batteries, such as to send data relating to operation of the batteries, such as over-the-air firmware update (OTA), configuration updates, etc.

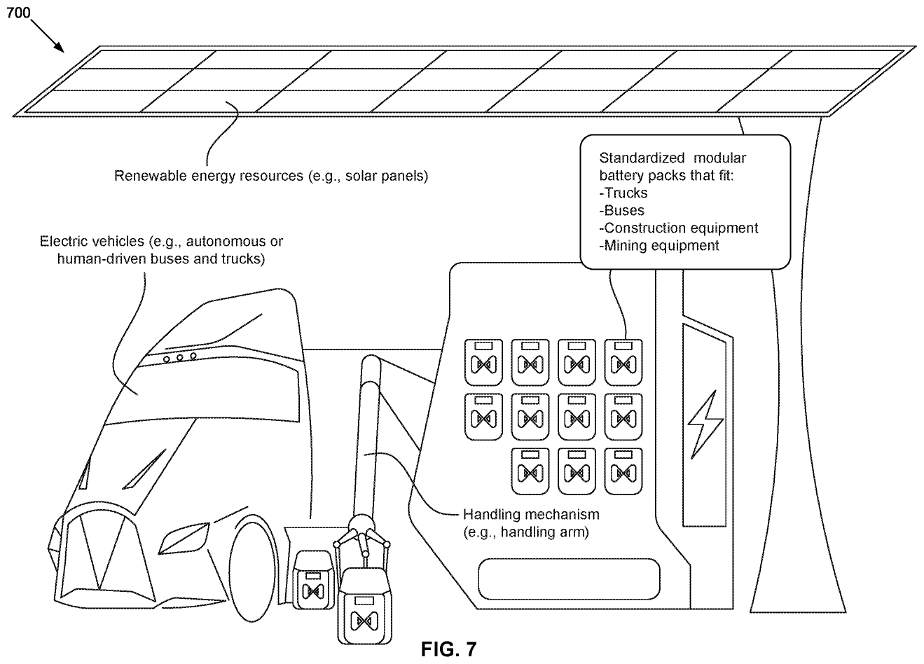

FIG. 7 illustrates an example battery-swapping fueling station. Shown in FIG. 7 is a battery-swapping fueling station 700 configured for supporting battery swapping services.

The battery-swapping fueling station 700 may be configured for supporting swapping of batteries in electric vehicles as described herein. In this regard, battery-swapping fueling station 700 may be configured performing battery swapping operations in efficient manner, particularly to ensure doing so in relatively short time (e.g., few minutes) so that “fueling” electric vehicles may be comparable to conventional fueling.

The battery-swapping fueling station 700 may comprise various components for facilitating and supporting the battery swapping operations, as well as for supporting ancillary functions and services. For example, in the implementation illustrated in FIG. 7, the battery-swapping fueling station 700 comprises standardized modular battery packs, battery handling mechanism(s), battery charger(s), grid connectors, and communication resources.

The standardized modular battery packs comprises housings or bays for inserting batteries therein. In this regard, the battery housings or bays may be configured based on a standardized battery size (with the housings or bays in the electric vehicles similarly configured based on the same battery-swapping fueling station 700). The battery packs may be implemented as (or housed within) a secure container, to ensure safe and secure in operation under all conditions (particularly in an outdoor environment). This may comprise use of weather-proofing measures, use of strong and shock resistance material on exterior, incorporating measures to protect against impact (e.g., vehicle hitting the racks), etc.

The battery handling mechanism(s) may be configured for use in handling batteries in conjunction with the operation of the battery-swapping fueling station. For example, the battery handling mechanism(s) may be configured for use in swapping batteries in electric vehicles—e.g., removing batteries in the vehicles, placing them in open housings/bays in the racks (or on the side, if none are open), removing batteries from the racks and inserting them into the vehicle. The battery handling mechanism(s) may also be configured for use in transport and/or placement/removal of batteries into and/or out of the battery racks during non-refueling operations (e.g., when loading or unloading the battery-swapping fueling station, such as by operator of the station). Various designs or solutions may be used in implementing the battery handling mechanism(s), and the disclosure is not limited to any particular design or approach. For example, the battery handling mechanism(s) may be implemented using carts, arms, rails, etc., or any combination thereof. Further, the design and/or implementation of the battery handling mechanism(s) may be adaptively set or adjusted, such as based on the operation of battery handling mechanism(s) (e.g., mode of operation, which may comprise such modes as fully-autonomous, semi-autonomous, manual mode, remotely-controlled, etc.). An example implementation using a handling arm is described in more detail below, with respect to FIG. 7.

The battery charger(s) may be configured for charging batteries inserted in the housing/bays of the battery racks. In this regard, the battery charger(s) may be implemented as separate components, or may be incorporate into the battery racks (or even into the individual housing/bays of the battery racks). Power used in charging may be obtained from the electrical grid (via suitable connections between the station and the electrical grids) and/or from local sources. In this regard, in some instances, battery-swapping fueling stations (e.g., the battery-swapping fueling station 700) may incorporate resources for generation of renewable energy, such as by using solar panels (as illustrated in FIG. 7), wind turbines, and the like. Relatedly, battery packs maybe configurable as distributed energy resources (DERs) to enable feeding electricity into the electrical grid (when needed).

The communication resources may comprise radios, transceiver circuitry, etc. to support communication operations (e.g., wired, wireless, etc.). This may enable communicating with batteries when inserted, communication with the vehicles (e.g., when using or approaching the station), communication with centralized entities (e.g., cloud-based servers, main control facilities, etc.).

In some instances, battery-swapping fueling stations (e.g., the battery-swapping fueling station 700) may support or incorporate additional measures for enhancing safety, particularly during battery swapping operations. For example, batteries may be hot swappable, connectors (in the station and/or vehicle) may incorporate securing components, to ensure the batteries are secured once inserted, and the like.

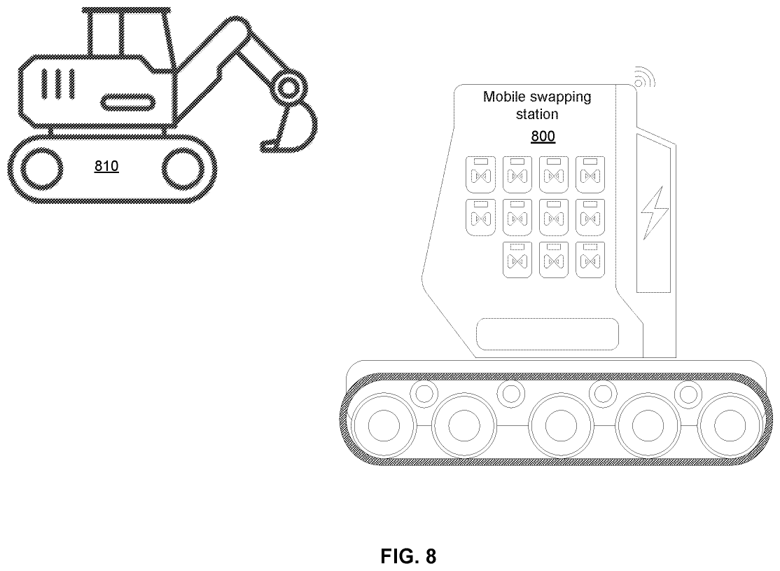

FIG. 8 illustrates an example mobile battery-swapping fueling station. Shown in FIG. 8 is a mobile battery-swapping fueling station 800 configured for supporting battery swapping services.

The mobile battery-swapping fueling station 800 may be substantially similar to the battery-swapping fueling station 700, and may operate in substantially similar manner. However, the mobile battery-swapping fueling station 800 may also be configured for mobility—that is, supporting mobile operation, particularly for providing fueling services in mobile manner. For example, the mobile battery-swapping fueling station 800 may comprise, similar to the battery-swapping fueling station 700, such components as racks with battery bays/housings, battery handling mechanism(s), chargers, etc., but rather than being installed at a fixed location, these components may be deployed on a moving platform, such as a wheeled or tracked chassis. This may enable moving the mobile battery-swapping fueling station 800, such as for redeployment and/or for bringing the battery swapping services to the electric vehicles.

Such mobility may be particularly desirable with certain operation conditions and/or with certain types of electric vehicles. For example, use of mobile battery-swapping fueling stations may be desirable in conjunction with such operation conditions as construction and mining. Thus, mobile battery-swapping fueling stations (e.g., the mobile battery-swapping fueling station 800) may be (re-)deployed to construction sites or mining locations, as needed, and/or may be moved to the construction or mining equipment to provide the battery swapping services on-site, as illustrated in FIG. 8 (with the mobile battery-swapping fueling station 800 operating at a mining site, providing battery swapping services to an electric excavator 810).

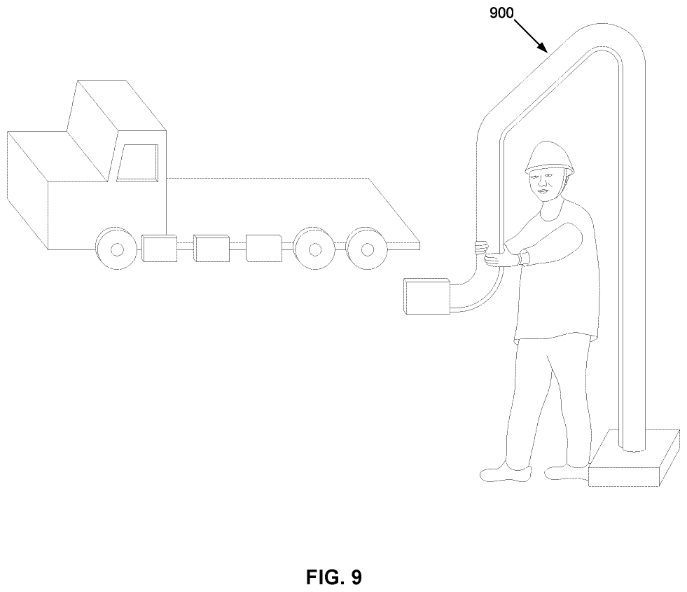

FIG. 9 illustrates an example powered battery handling arm for use in swapping batteries in a battery-swapping fueling stations. Shown in FIG. 9 is a handling arm 900 which may be used in battery-swapping fueling stations (e.g., the battery-swapping fueling station 700 of FIG. 7 and/or the battery-swapping fueling station 800 of FIG. 8).

The handling arm 900 may comprise suitable hardware (and related suitable circuitry) for use in moving batteries between the battery-swapping fueling stations (particularly, from components that house the swappable batteries therein, such as racks of battery bays) and vehicles using the battery-swapping fueling stations. The handling arm 900 may be adaptively configured for handling the batteries and swapping thereof, such as based on the manner of inserting/removing of the battery. For example, as illustrated in FIG. 9, the handling arm 900 may be configured for inserting/removing batteries in drawer-like slide motions.

The handling arm 900 may be configured for operations in one or more of a plurality of possible modes of operation. For example, the handling arm 900 may be configured for operation in fully-autonomous mode (e.g., without any involvement by a human, whether an operator of the station or the vehicle), in semi-autonomous mode (e.g., based on combined actions of a human and machine), and in manual mode, with the human operator (user of the vehicle or operator of the station) operating the handling arm 900 to facilitate the insertion and/or removal of batteries. Nonetheless, even in the manual mode, some measure of mechanical contribution may still be used (e.g., some hydraulics or pneumatics capabilities for assisting the operator in gripping, manipulating and moving the batteries). Handling arms (e.g., the handling arm 900) may also support a remotely-controlled mode, where an operator (e.g., one or both of the EV operator and a station operator) may remotely control at least some of the operation of handling arm—e.g., the insertion of the batteries. For example, the arm may be remotely operated, such as from a “call center”.

The design and implementation of handling arms (e.g., the handling arm 900) may incorporate additionally measures or component for accounting for and assisting with various conditions that are pertinent to battery swapping operations. For example, the handling arm 900 may incorporate sensors (e.g., visual, or the like) to ensure accurate positioning of the batteries when inserting them into the vehicle or the battery-swapping fueling station. The battery-swapping fueling station may incorporate additional measures to ensure meeting other required precision criteria, particularly with respect to the vehicles using the battery-swapping fueling stations. For example, battery-swapping fueling station may be designed and/or may incorporate sensors to ensure precision of vehicle parking during swapping operations.

The handling arms may also configured to account for various types of vehicles (and particularly variations in size thereof) to ensure that these arms may be used with different vehicle sizes (bus, small truck, big truck, construction or mining equipment, etc.). Further, handling arms may be configured for outdoor operation, and as such may be weather-proofed to ensure operation in different weather and environmental conditions (dirt, rain, snow, etc.). In some implementations, the handling arms may incorporate measures for protection against inadvertent adverse operation (particularly in conjunction with manual mode of operation).

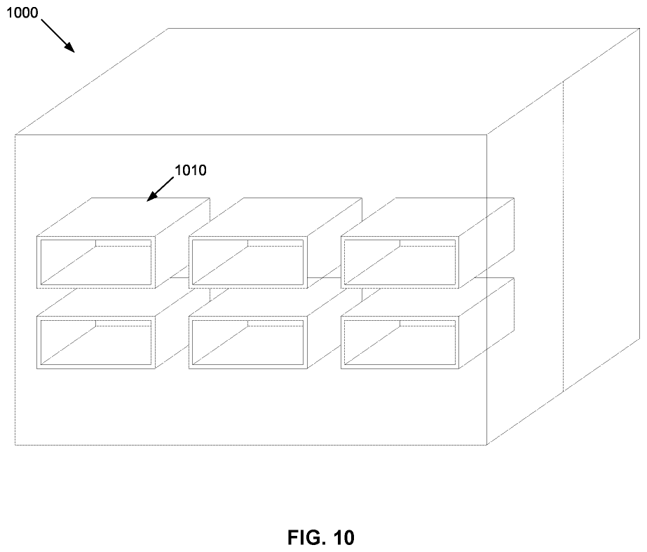

FIG. 10 illustrates an example rack of battery bays for use in battery-swapping fueling stations. Shown in FIG. 10 is a rack 1000 which may be used in battery-swapping fueling stations (e.g., the battery-swapping fueling station 700 of FIG. 7 and/or the mobile battery-swapping fueling station 800 of FIG. 8).

The rack 1000 may comprise a plurality of battery bays 1010, each configured for receiving and mating with a swappable battery. In this regard, the battery bays 1010 are configured such that they match the vehicle battery housings. In some instances, each of the battery bays 1010 may incorporate a rack-based battery interface for engaging and operating batteries when such batteries are inserted therein.

The rack-based battery interface may be substantially similar to the battery interface 500 used in the vehicle battery housing, for supporting interactions between the battery and the electric vehicle. The battery interface used in the rack 1000 may be modified, however, to allow providing power to the battery, to facilitate charging thereof. In some instances, the rack-based battery interface may also support communication between the rack (and thus the battery-swapping fueling station) and the battery, which may ensure that the batteries may remain cloud-connected while inserted into the rack.

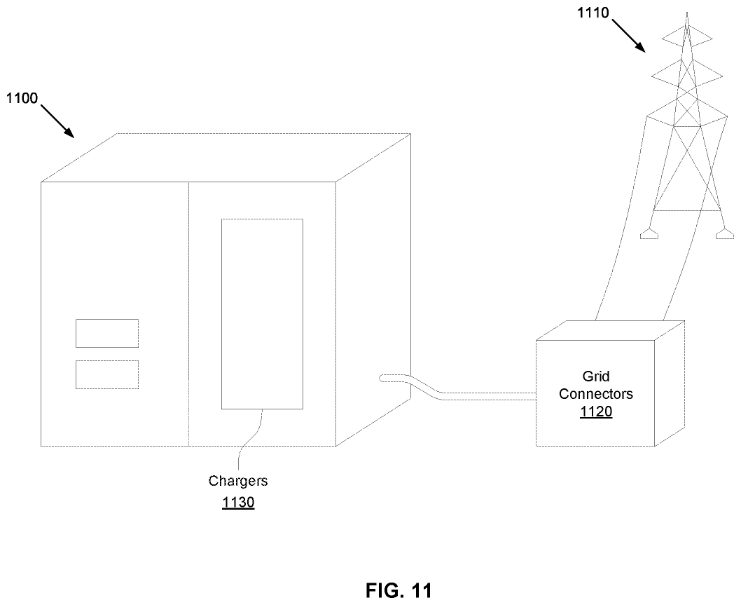

FIG. 11 illustrates example grid connections of a battery-swapping fueling station. Shown in FIG. 11 are battery-swapping fueling station 1100, electrical grid 1110 (or portion thereof), and grid connectors 1120.

The battery-swapping fueling station 1100 may be similar to the battery-swapping fueling station 700 of FIG. 7 and/or the battery-swapping fueling station 800 of FIG. 8. The electrical grid 1110 may be similar to the electrical grid 150 as described with respect to FIG. 1. In this regard, the portion of electrical grid 1110 that is closest to the battery-swapping fueling station 1100, and to which the battery-swapping fueling station 1100 may be connected, may comprise high voltage/power transmission lines.

The grid connectors 1120 may comprise hardware (and related circuitry) configured for providing connectivity between the battery-swapping fueling station 1100 and the electrical grid 1110, and for applying various functions associating with facilitating the supply of electrical power from the electrical grid 1110 to the battery-swapping fueling station 1100. Such functions may comprise, for example, required voltage adjustments (e.g., stepping down voltage, etc.) and the like. The grid connectors 1120 may comprise switches, step-down transformers, etc.

In operation, the grid connectors 1120 may be used to supply electric power from the electrical grid 1110 to the battery-swapping fueling station 1100, and may apply any required adjustments to ensure the supplied power meets any preset criteria (e.g., particular voltage range, type, etc.). The battery-swapping fueling station 1100 may use the supplied power in charging swappable batteries that are in the battery-swapping fueling station 1100 (e.g., inserted in to battery bays in racks, such as the rack 1000 of FIG. 10). In this regard, battery-swapping fueling stations (e.g., the battery-swapping fueling station 1100) may comprise dedicated components for utilizing the received power in charging operations. For example, as illustrated in FIG. 11, the battery-swapping fueling station 1100 may comprise one or more charging components 1130. The charging component 1130 may comprise, for example, a direct current fast charger (DC FC).

In some instances, battery-swapping fueling stations (e.g., the battery-swapping fueling station 1100) may be used to supply power back into the electrical grid. This may be done in instances where the battery-swapping fueling stations incorporate means for generating power (e.g., using solar panels) and/or even from batteries in the battery-swapping fueling stations (e.g., in cases of emergency). Accordingly, the grid connectors 1120 may be configured to facilitate providing power in that direction—that is, providing power into the electrical grid-including providing any required adjustments (e.g., step-up voltage, etc.).

In some implementations, battery-swapping fueling stations may be configured for supporting selective or temporary connectivity to the electrical grids. This may be particularly done in mobile battery-swapping fueling stations, such as the mobile battery-swapping fueling station 800 of FIG. 8 for example. Such selective connectivity allows for disconnecting from the electrical grid when the station is on the move, and for connecting only when needing to charge batteries inserted in the station.

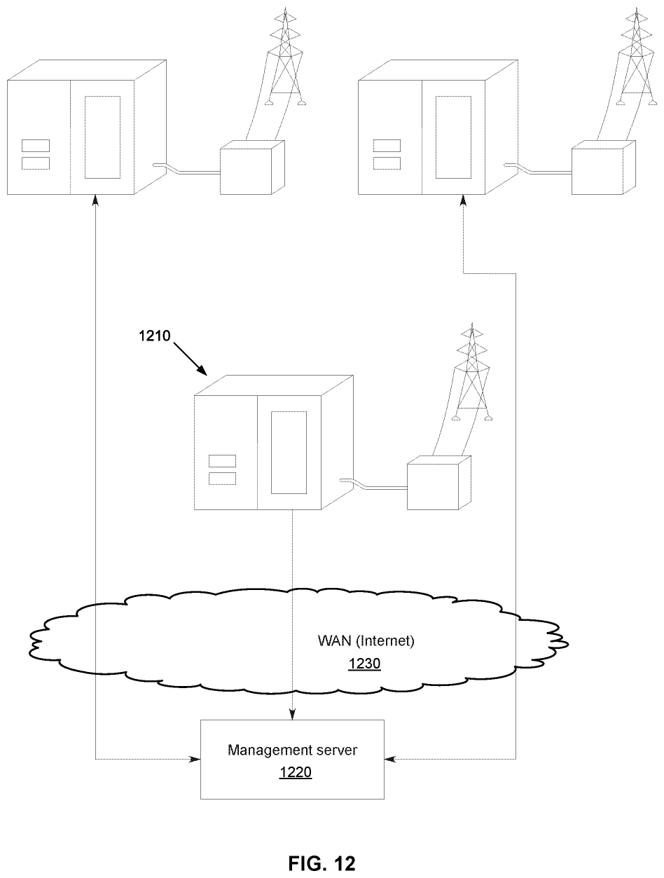

FIG. 12 illustrates example use of battery-swapping fueling stations with cloud-based control system. Shown in FIG. 12 is a cloud-based network 1200 configured for managing a plurality of battery-swapping fueling stations 1210. The cloud-based network 1200 may comprise a cloud-based management server 1220, which may interact with, and provide management services relating to, the plurality of battery-swapping fueling stations 1210, such as via wide area network (WAN) (e.g., Internet-based cloud) 1230.

The cloud-based management server 1220 may be configured to manage, support, and control battery-swapping fueling stations and use thereof as described in this disclosure. The cloud-based management server 1220 may comprise, for example, suitable circuitry (including, e.g., one or more of communication circuit(s), circuit(s), processing circuit(s), etc.) for performing the various functions and/or operations attributed to the cloud-based management server 1220, particularly with respect to managing, supporting, and controlling battery-swapping fueling stations.

While the cloud-based management server 1220 is illustrated in FIG. 12 as a single device/system, the disclosure is not so limited. In this regard, in some instances, solutions in accordance with the present disclosure may be implemented in a distributed manner, with various functions attributed to the cloud-based management server 1220 being performed by various elements (e.g., servers or other suitable systems) within or coupled to the WAN 1230. Thus, in some example implementations, the cloud-based management server 1220 may be implemented in a distributed manner, with some of the functions and/or operations attributed thereto being performed by different physical systems, devices or components that are part of and/or connected to the WAN 1230.

In various implementations, battery-swapping fueling stations may be configured to support communication functions, and as such may be cloud-connected. This may be done by, for example, incorporating communication related resources (e.g., radios, transceiver circuitry, etc.) into the battery-swapping fueling stations. Alternatively, the battery-swapping fueling stations may utilize other systems for providing and facilitating communication services.

The cloud-connectivity may be utilized to support and/or optimize operation of the battery-swapping fueling stations. For example, the battery-swapping fueling stations may be configured to utilize the cloud-connectivity to continuously send data to cloud-based management servers (e.g., the cloud-based management server 1220), which may use that data in enhancing or optimizing operation of the battery-swapping fueling stations. The cloud-based management servers (e.g., the cloud-based management server 1220) may also utilize the cloud-connectivity to communicate with the battery-swapping fueling stations, such as to send data relating to operation of the battery-swapping fueling stations and optimizing thereof. For example, the cloud-based management servers (e.g., the cloud-based management server 1220) may generate and communicate to the battery-swapping fueling stations such data as charger control firmware updates, grid level optimization (e.g., for minimizing peak demand), etc.

In some instances, the cloud-connectivity between the cloud-based management servers (e.g., the cloud-based management server 1220) and battery-swapping fueling stations may be utilize for facilitating interactions with the batteries at the battery-swapping fueling stations (e.g., when inserted within the racks of battery bays, or when inserted/mated to electric vehicles that may be the refueling in the battery-swapping fueling stations). For example, the cloud-connectivity between the cloud-based management servers (e.g., the cloud-based management server 1220) and battery-swapping fueling stations may enable use of batteries inserted into the battery-swapping fueling stations batteries distributed energy resources (DERs). Such use of the batteries may offer various benefits, such as allowing for the capability to sell energy back to the grid, facilitating smart transaction execution on electricity markets, etc.

An example system, in accordance with the present disclosure, for providing end-to-end infrastructure for supporting use of electric vehicles, comprises one or more battery-swapping fueling stations. Each battery-swapping fueling station is configured to maintain one or more swappable batteries configured for operation in the electric vehicles, charge each of the one or more swappable batteries, when not fully charged, and swap, using the one or more swappable batteries, at least one battery of at least one electric vehicle when the at least one electric vehicle is refueling at the battery-swapping fueling station.

In an example implementation, at least one of the one or more battery-swapping fueling stations is configured for supporting communication functions.

In an example implementation, at least one of the one or more battery-swapping fueling stations is configured for mobile operation.

In an example implementation, at least one of the one or more battery-swapping fueling stations is configured for generating power autonomously.

In an example implementation, the system further comprises one or more connection components configured for connecting at least one of the one or more battery-swapping fueling stations to an electrical grid for obtaining power therefrom.

In an example implementation, at least one of the one or more battery-swapping fueling stations is configured to provide power to an electrical grid.

In an example implementation, the at least one of the one or more battery-swapping fueling stations is configured to provide the power from one or both of the one or more batteries and one or more power generation resources in the at least one of the one or more battery-swapping fueling stations.

In an example implementation, each of the one or more battery-swapping fueling stations is configured to operate in one of a plurality of modes during swapping operations, where the plurality of modes comprises a fully-autonomous mode, a semi-autonomous mode, a manual mode, and a remotely-controlled mode.

In an example implementation, each of the one or more battery-swapping fueling stations is configured to, during swapping operations, authenticate one or more of an electric vehicle having its batteries swapped, each swapped battery, and a user associated with the electric vehicle.

In an example implementation, the system further comprises one or more cloud-based servers configured for managing operations in the end-to-end infrastructure.

In an example implementation, at least one of the one or more battery-swapping fueling stations is configured for communicating with at least one of the one or more cloud-based servers, where the communicating comprises sending data and receiving management related information.

In an example implementation, at least one of the electric vehicles is configured for communicating with at least one of the one or more cloud-based servers, where the communicating comprises sending data and receiving management related information.

In an example implementation, the system further comprises one or more components configured for handling one or both of recycling and/or disposal of components and/or equipment used in the end-to-end infrastructure.

In an example implementation, each of the one or more swappable batteries is configured for fitting into matching housing in the one or more battery-swapping fueling stations and the electric vehicles.

An example method, in accordance with the present disclosure, for providing end-to-end infrastructure for supporting use of electric vehicles, comprises, in each of one or more battery-swapping fueling stations: maintaining one or more swappable batteries configured for operation in the electric vehicles, charging each of the one or more swappable batteries, when not fully charged, and swapping, using the one or more swappable batteries, at least one battery of at least one electric vehicle when the at least one electric vehicle is refueling at the battery-swapping fueling station.

In an example implementation, the method further comprises generating power autonomously in at least one of the one or more battery-swapping fueling stations.

In an example implementation, the method further comprises obtaining power in at least one of the one or more battery-swapping fueling stations from an electrical grid via connections to the electrical grid.

In an example implementation, the method further comprises providing power from at least one of the one or more battery-swapping fueling stations to an electrical grid via connections to the electrical grid.

In an example implementation, the method further comprises providing the power from one or both of the one or more swappable batteries and one or more power generation resources in the at least one of the one or more battery-swapping fueling stations.

In an example implementation, wherein each of the one or more battery-swapping fueling stations is configured to operate in one of a plurality of modes during swapping operations, where the plurality of modes comprises a fully-autonomous mode, a semi-autonomous mode, a manual mode, and a remotely-controlled mode.

In an example implementation, the method further comprises authentication, during swapping operations, one or more of an electric vehicle having its batteries swapped, each swapped battery, and a user associated with the electric vehicle.

In an example implementation, the method further comprises managing, using one or more cloud-based servers, operations in the end-to-end infrastructure.

In an example implementation, the method further comprises handling in the end-to-end infrastructure one or both of recycling and/or disposal of components and/or equipment used in the end-to-end infrastructure.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for providing end-to-end infrastructure for supporting use of electric vehicles, the system comprising:
one or more battery-swapping fueling stations, wherein each battery-swapping fueling station is configured to:
maintain one or more swappable batteries configured for operation in the electric vehicles;
charge each of the one or more swappable batteries, when not fully charged; and
swap, using the one or more swappable batteries, at least one battery of at least one electric vehicle when the at least one vehicle is refueling at the battery-swapping fueling station.

2. The system of claim 1, wherein at least one of the one or more battery-swapping fueling stations is configured for supporting communication functions.

3. The system of claim 1, wherein at least one of the one or more battery-swapping fueling stations is configured for mobile operation.

4. The system of claim 1, wherein at least one of the one or more battery-swapping fueling stations is configured for generating power autonomously.

5. The system of claim 1, further comprising one or more connection components configured for connecting at least one of the one or more battery-swapping fueling stations to an electrical grid for obtaining power therefrom.

6. The system of claim 1, wherein at least one of the one or more battery-swapping fueling stations is configured to provide power to an electrical grid.

7. The system of claim 6, wherein the at least one of the one or more battery-swapping fueling stations is configured to provide the power from one or both of the one or more batteries and one or more power generation resources in the at least one of the one or more battery-swapping fueling stations.

8. The system of claim 1, wherein each of the one or more battery-swapping fueling stations is configured to operate in one of a plurality of modes during swapping operations, the plurality of modes comprising a fully-autonomous mode, a semi-autonomous mode, a manual mode, and a remotely-controlled mode.

9. The system of claim 1, wherein each of the one or more battery-swapping fueling stations is configured to, during swapping operations, authenticate one or more of: an electric vehicle having its batteries swapped, each swapped battery, and a user associated with the electric vehicle.

10. The system of claim 1, further comprising one or more cloud-based servers configured for managing operations in the end-to-end infrastructure.

11. The system of claim 10, wherein at least one of the one or more battery-swapping fueling stations is configured for communicating with at least one of the one or more cloud-based servers, the communicating comprising sending data and receiving management related information.

12. The system of claim 10, wherein at least one of the electric vehicles is configured for communicating with at least one of the one or more cloud-based servers, the communicating comprising sending data and receiving management related information.

13. The system of claim 1, further comprising one or more components configured for handling one or both of recycling and/or disposal of components and/or equipment used in the end-to-end infrastructure.

14. The system of claim 1, wherein each of the one or more swappable batteries is configure for fitting into matching housing in the one or more battery-swapping fueling stations and the electric vehicles.

15. A method for providing end-to-end infrastructure for supporting use of electric vehicles, the method comprising:
in each of one or more battery-swapping fueling stations:
maintaining one or more swappable batteries configured for operation in the electric vehicles;
charging each of the one or more swappable batteries, when not fully charged; and
swapping, using the one or more swappable batteries, at least one battery of at least one electric vehicle when the at least one electric vehicle is refueling in the battery-swapping fueling station.

16. The method of claim 15, further comprising generating power autonomously in at least one of the one or more battery-swapping fueling stations.

17. The method of claim 15, further comprising obtaining power in at least one of the one or more battery-swapping fueling stations from an electrical grid via connections to the electrical grid.

18. The method of claim 15, further comprising providing power from at least one of the one or more battery-swapping fueling stations to an electrical grid via connections to the electrical grid.

19. The method of claim 18, further comprising providing the power from one or both of the one or more swappable batteries and one or more power generation resources in the at least one of the one or more battery-swapping fueling stations.

20. The method of claim 15, wherein each of the one or more battery-swapping fueling stations is configured to operate in one of a plurality of modes during swapping operations, the plurality of modes comprising a fully-autonomous mode, a semi-autonomous mode, a manual mode, and a remotely-controlled mode.

21. The method of claim 15, further comprising authentication, during swapping operations, one or more of: an electric vehicle having its batteries swapped, each swapped battery, and a user associated with the electric vehicle.

22. The method of claim 15, further comprising managing, using one or more cloud-based servers, operations in the end-to-end infrastructure.

23. The method of claim 15, further comprising handling in the end-to-end infrastructure one or both of recycling and/or disposal of components and/or equipment used in the end-to-end infrastructure.
